(19) United States
(12) Patent Application Publication
(10) Pub. No.: US 2002/0097728 A1
(43) Pub. Date: Jul. 25, 2002

(54) Method and apparatus for injection of IP multicast content into an ATM DSL network

(75) Inventors: Larry W. Hinderks, Reno, NV (US); Ryland Reed, Dallas, TX (US); Gregory Preston, Colleyville, TX (US); Timothy Hegwood, McKinney, TX (US)

Correspondence Address: NIXON & VANDERHYE P.C., 8th Floor, 1100 North Glebe Road, Arlington, VA, 22201, US

(73) Assignee: STARGUIDE DIGITAL NETWORKS, INC.

(21) Appl. No.: 09/988,020

(22) Filed: Nov. 16, 2001

Related U.S. Application Data
(60) Provisional application No. 60/249,290, filed on Nov. 17, 2000.
(60) Provisional application No. 60/254,864, filed on Dec. 11, 2000.

(51) Int. Cl. H04L 12/56

(52) U.S. Cl. 370/395.52; 370/432

(57) ABSTRACT

A method and apparatus enables legacy NSP and other networks which use ATM switches that lack multicasting capabilities to acquire and distribute IP multicast transmissions to content subscribers on ATM DSL networks. The method and apparatus further provides the ability for insertion of local advertising content into received IP streams for subsequent distribution over an ATM network. An IP ATM Multicaster (IAM) converts IP multicast signals to ATM protocol and replicates the converted IP multicast packets in response to IGMP join requests received from one or more prospective multicast content recipients. The IAM acts as a bridge between IP protocol and ATM protocol environments that handles conversions and encapsulation protocols between environments. An alternate embodiment utilizes an ATM IP Multicast Inserter (AIMI) that embodies similar functions as the IAM but without using multiple virtual circuits. A Local Ad Inserter (LAI) is provided for enabling insertion of advertisements into the IP multicast data stream prior to insertion into the ATM network.

### CROSS-REFERENCES TO RELATED APPLICATIONS

The present invention claims priority from related provisional applications Ser. No. 06/249,290, filed Nov. 17, 2000, entitled “Method and Apparatus For Injecting IP Multicast Content Into An ATM DSL Network and Ser. No. 06/254,864 (Atty docket No. 3593-21), filed Dec. 11, 2000, entitled “Multicast Broadcast Insertion Into An ATM DSL Network”, both of which are incorporated by reference into this specification.

### FIELD OF THE INVENTION

The present invention relates to multicasting digital audio/video content, and more particularly to the delivery and injection of IP multicast content into existing ATM DSL networks as well as inserting local commercial and/or personal advertisement content into delivered multicast content streams.

### BACKGROUND AND ASPECTS OF THE INVENTION

Multiple channels of digital audio/video content can be reliably distributed by bypassing a large portion of the conventional Internet communications infrastructure with a dedicated high bandwidth communications network and delivering the digital content as near as physically possible to one or more intended end-user recipients. See, for example, commonly assigned U.S. Pat. Nos. 6,101,180, 6,262,982 and 6,266,339, respectively issued on Aug. 8, 2000, Jul. 17, 2001 and Jul. 24, 2001 to Donahue et al., and all entitled “High Bandwidth Broadcast System Having Localized Multicast Access To Broadcast Content.” During or prior to distribution of digital IP (Internet Protocol) multicast content, prospective recipients may submit a request to receive or “join” in the reception of the transmitted content. This arrangement is often referred to as a “join-in-progress” content transmission. Such join-in-progress IP multicast content may also be delivered over both “one-way” as well as “two-way” communications networks. One preferred means for delivering such “join-in-progress” IP multicast content is an earth orbiting Satellite transmission distribution network. Another example is a dedicated high bandwidth terrestrial transmission network.

Asynchronous transfer mode (ATM) networks are a well-known and popular type of wide area network (WAN) digital data transport infrastructure. In this context, the delivery of IP multicast audio and video content is a commercially important subset of the more general challenge of delivering IP multicast over an ATM network. An overview of this basic challenge of delivering IP multicast over an ATM network is discussed, for example, in chapter 20.5 of “ATM Theory and Applications” by David McDysan and Darren Spohn, Signature Edition, McGraw-Hill, 1999. (The general challenge of delivering IP multicast may be found as described, for example, in the Official Internet Protocol standards RFC 1112 and RFC 2236, as described in RFC 2022.)

Conventionally, an Internet Protocol (IP) infrastructure transports data via a “connectionless” network, whereas ATM protocol is a protocol for transporting data via a connection-oriented network. One particularly advantageous quality of ATM protocol is that telephone companies may efficiently carry voice traffic as well as data traffic over a single network. Because most data traffic is based on the IP connectionless transport network, much work has been done to map IP networks onto an ATM networks. For example, contemporary data networks typically consist of local area networks that are predominantly based on IP and Ethernet/802.3, while most wide area networks are often based on ATM protocol.

A basic tenet of ATM protocol is that data is transported via a 53-byte data cell wherein the first five bytes of the cell constitute a header and the last forty-eight bytes constitute the data payload. This fixed-length cell architecture gives ATM switches the ability to quickly manipulate the cells for delivery to the proper designation. The five byte header typically contains all the information necessary for the data cell to be efficiently transmitted by an ATM network through a few basic switching elements known as the VPI (virtual path identifier) and the VCI (virtual channel identifier), which define a “virtual circuit” in the ATM infrastructure.

Basic IP Multicast Overview

FIG. 1 shows a basic example of an IP multicast transmission system arrangement. In this example, a multicast content source, 1250, is connected to a router, 1254. The router is connected to a LAN, 1260, that is connected, in turn, to Various IP host computers, 1262 and 1258, which share the LAN. In this simplified example of an IP multicast arrangement, source 1250 continuously sends UDP packets to router 1254. Conventionally, the address range available for IP multicast use is the IP addresses from 224.0.0.0 to 254.255.255.255 (called the group address) and the packets are delivered by UDP.

When a particular host (e.g., 1258) wants to receive IP multicast packets from a specific group address, it sends an IGMP (Internet Group Management Protocol) “join” request (see RFC 2236) to router 1254. Router 1254 will not forward the packets generated by multicast source 1250 prior to receiving such a join request, since it is initially programmed to assume that no host computer wants such packets. Upon receiving the join request for a specific IP address, router 1254 allows packets associated with the associated group address to flow from multicast source 1250 onto LAN 1260, where they are received by host 1258. If host computer 1262 subsequently requests the multicast data packets from the same group, for example, by sending a “join” request to router 1254, the router, in this case, need do nothing further because multicast packets are already flowing to LAN 1260 in response to the prior join request from host 1258.

Host computers (1262 and 1258) may also send IGMP “leave” requests to the router (see, for example, RFC 2236). Preferably, the router is sophisticated enough to know how many hosts are joined to each group address so that it can keep the multicast packets flowing onto the LAN until the last host issues its leave request. This simplified overview of an IP multicast arrangement illustrates the control that the system router has over the multicast data generated by the multicast source. (For further information see RFC 2236 which describes the multicast protocol including the structure and use of the join, leave, query and report IGMP messages.)

Example ATM Encapsulation

FIG. 2 illustrates how a typical data packet, such as an IP packet, is transformed into ATM cells. Various encapsulation bits (2002) may envelope the IP data (2000) during the process of becoming ATM cells. For example, an ATM adaptation layer (AAL), shown at block 2004, adds an encapsulation that is specific to ATM. (Such encapsulations are described in greater detail, for example, in RFC 1483 and RFC 2516.) In general, the various encapsulations add header and trailer bytes that contain information such as the packet length and packet checksum. As shown in FIG. 2, the encapsulation process is illustrated using the following simple labels: HE indicates an encapsulation header; TE indicates an encapsulation trailer, HAL indicates the ATM adaptation layer header, TAL indicates the ATM adaptation layer trailer, and HA indicates the ATM cell header.

Although the ATM protocol has multiple adaptation layers, more definitively known as AAL1 through AAL5, only AAL5 is used in most contemporary data networks. (For example, whereas AAL1 is specific to voice traffic transported over an ATM network, AAL5 may additionally handle multiple types of content data but only adds a trailer to each packet.) Once the AAL encapsulation is performed, the resultant data packet is broken up into 48-byte cells, called the “payload”, and a 5-byte (HA) header is added to the payload to form the 53-byte ATM cell 2006 which then is transmitted through an ATM network. This process is often called serial assembly and re-assembly (SAR).

### EXAMPLE LAYER-3 NETWORK

FIG. 3 shows an example “layer-3” communications network arrangement which is used for distributing IP multicast content injected into the Internet at various ISP points of presence and which may be used to illustrate the conventional layer-3 relationship between the Internet 200, an Internet Service Provider (ISP) 300 and a Network Service Provider (NSP) 400. An Internet connected router 201, is connected to router 301 of ISP 300 which is in turn connected to router 401 at NSP 400. Such a network of interconnected routers is commonly referred to as a “layer-3” connnectionless network because the digital communications traffic carried on communication paths/links 202 and 302 is provided in Internet Protocol (IP) designated by a standardized four-byte (IPv4) or eight-byte (IPv6) addressing header in which data is routed by examining the associated IP addresses. Such network arrangements are extremely flexible and form the basis of the Internet infrastructure.

One role of an NSP is to connect Internet end-users to Internet Service Providers such as ISP 300. In contrast, one primary role of the ISP is to connect the local network to the national Internet backbone. In the “dialup” data access world, NSP infrastructure 400 would be the telephone companies' Plain Old Telephone Network (POTS). In the broadband world, infrastructure 400 would be an XDSL (extended digital subscriber line) network provided by Incumbent Local Exchange Carriers (ILECS) and Competitive Local Exchange Carriers (CLECs).

Within the NSP infrastructure 400, a DSLAM (Digital Subscriber Line Asynchronous Multiplexer) 500 is connected to an end-user computing device 700 via, for example, router 601 and DSL modem 602. Alternately, modem 602 may be integrated inside router 601. In FIG. 3, DSLAM 500 is also shown connected directly to end-user computing device 710 via DSL modem 503. Lines/connections 604 and 504 are typically either Ethernet or ATM communication links/interfaces. The function of DSL modems 602 and 503 is to convert the signals on digital transmission/communication lines 604 and 504 into signals suitable for transport over the POTs or LECs twisted-wire copper lines 501 and 502. In the case of ADSL modems, there are several standards that govern the characteristics of the signals on the copper wires. However, between a DSLAM unit and conventional DSL modems, ATM (Asynchronous Transfer Mode) has been standardized as the communication protocol for use from DSLAM 500 to DSL modems 602 and 503. A further communication protocol, namely that specified by RFC 1483, is often used for mapping IP traffic onto ATM transport.

In this example, the primary function of DSLAM 500 is to send and receive digital communication signals to/from DSL modems and to multiplex the signals onto transmission line 402 for transport to/from NSP 400. Typically, a Permanent Virtual Circuit (PVC) is established from router 401 to a particular client computer (710) or to a particular client router (601). Basically, a PVC is an ATM concept that means that there is effectively a direct connection from modems 602 and 502 to router 401. (The term “virtual” is used since there actually may be multiple “direct connections” all traveling on the same physical facility 402.)

An IP multicast signal may be inserted (injected) at any Internet gateway/router (R) along the layer-3 network path to the end-user. For example, as illustrated in FIG. 3, an IP multicast signals may be injected at routers 201, 301, 401 and 601. Injection of an IP multicast signal as close to the end-user as possible is preferable. The router closest to the user can then replicate the packets as needed in response to an IP “join” request (see, for example, RFC1112 and RFC2236). In the example network of FIG. 3, router 401 would make and distribute copies of multicast packets to one or more end-users (700, 710) if requested by an end-user via a “join” request. Intermediate routers between a point of IP multicast signal injection (for example, 403 or 603) and the last router before the end-user (IP multicast content recipient) would forward only a single copy of the injected IP multicast signal—as dictated, for example, by a conventional inter-router protocol such as PIM-sparse.

In the case of a satellite IP multicast signal feed, a satellite receiving antenna (206) and a satellite receiver (204) is required to receive the signal and provide it to a router. For example, a StarGuide III™ satellite receiver is ideally suited for receiving CoolCaSt™ IP multicast signals and injecting the signals into a network because it has an Ethernet output module that can directly connect to routers. An injected IP multicast signal (203, 303, 403 or 603) could come from either satellite or terrestrial multicast sources. However, satellite delivery is often the most economical method of delivering multicast signals to a geographically disperse group of destinations. If a prospective end-user of multicast signal content has a router located close to a client (content recipient), then it is possible to inject an IP multicast signal into that router. Such an arrangement is illustrated in FIG. 3 by router 601 and recipient computer 700. One potential disadvantage of using router 601 as an injection point is that a satellite antenna and receiver would be required at that location and such equipment would add significantly to the overall per-user equipment cost.

Alternatively, Injecting an IP multicast signal (403) at the location of system router 401 at NSP 400 will allow both recipients 700 and 710 to receive IP multicast content. Moreover, injecting the multicast signal at the location of NSP router 401 allows all clients connected to any DSLAM that is connected to router 401 to receive the IP multicast signal. In the FIG. 3 example shown, it is also possible for router 601 to communicate with router 401 via some IP multicast routing protocol such as PIM-sparse. Although, this arrangement works well for most systems in which the network service provider (NSP) deploys a router within its network, one problem with injection of IP multicast into an NSP or ISP network is that many of the existing legacy networks have an ATM “switch” instead of a router (401) and operate as layer-2 networks. Unfortunately, it is not usually possible to inject an IP multicast layer-3 type signal directly into the ATM switch. Such an injection is possible only if the switch has the ability to convert IP layer-3 into ATM layer-2—a so called “switch router” (SR). Such conversions are typically difficult and the process is complicated by the need for the SR to also handle the conversion of IP multicasting into ATM multicasting.

Conventional ATM switches that have multicasting capability have what is known as “root initiated joins”. This means that some device external to the switch must tell the switch which source Virtual Path IdentifierNirtual Channel Identifier (VPI/VCI) should be copied into which destination VPI/VCIs. User level or “leaf” initiated joins, which require a Switched Virtual Circuit (SVC) as opposed to a permanent virtual circuit (PVC), have only recently been standardized and are not commonly implemented in older and low cost ATM switches. The present invention solves the above and other problems by providing a method and apparatus that enables legacy NSP and/or other networks which use ATM switches that lack multicasting capabilities to inexpensively acquire and distribute IP multicast transmissions with a minimum of additional equipment. In addition, the method and apparatus of the present invention provides for convenient local insertion of audio/video content, such as local commercials and tailored advertising, into the delivered multicast content streams.

Beneficial Aspects of the Present Invention

An IP ATM Multicaster (IAM) embodiment and an ATM IP Multicast Inserter (AIMI) embodiment are provided for use by an ISP or NSP for converting IP multicast signals to ATM protocol and replicating the converted IP multicast packets in response to IGMP “join” requests received from one or more prospective multicast content recipients. In this regard, the IAM and AIMI embodiments of the present invention act as a bridge between IP protocol and ATM protocol environments that handles protocol conversions and data encapsulations required between such environments. Basically, the IAM embodiment is intended primarily for use with customer premise equipment (CPE) that is configured and provisioned for operation with two or more ATM virtual circuits. Moreover, the IAM handles client (i.e., content recipient) “join” and “leave” requests for multicast operations and also allows local insertion of content into the distributed signal. The AIMI embodiment functions similarly to the IAM but provides enhanced processing to enable its use with more conventional customer premise equipment that typically uses only a single ATM virtual circuit (i.e., the AIMI version precludes any need to use customer premise equipment of the type that must be pre-configured to support at least two ATM virtual circuits).

One beneficial aspect of the IAM embodiment of the present invention is that an ATM network which uses legacy DSLAM (Digital Subscriber Line Asynchronous Multiplexer) units (e.g., units that only recognize unicast ATM) to distribute multicast content, may be easily enabled to permit local injection of an IP multicast signal in a relatively simple and inexpensive manner through the use of a low cost ATM switch and an IAM unit of the present invention.

One beneficial aspect of the AIMI embodiment of the present invention is that a second ATM virtual circuit is not needed at the CPE (e.g., the recipient's DSL modem). Consequently, less expensive customer premise equipment may be used. A further beneficial aspect of the AIMI embodiment is that the equipment used on either side of the AIMI may remain essentially the same after installation of an AIMI. In addition, whatever provisioning and maintenance systems are in place to manage the CPE may remain unchanged after installation of an AIMI.

A further advantage of any embodiment, in addition to the two example embodiments presented, is that the method and apparatus of the present invention provides control over the access of each content recipient with respect to specific multicast channels (i.e., enable/disable access control capabilities). A further advantage is that the disclosed apparatus integrates easily with existing ATM DSL networks.

A still further advantage of the methods and apparatus of the present invention is that it provides information as to which virtual circuit (i.e., user) is consuming (receiving) which IP multicast group address (i.e., multicast content channel).

Yet another advantage of the present invention is that it provides for advertisements (or other regional/locally generated specific content) to be inserted directly into received IP multicast content streams in a way that is transparent to multicast recipients/subscribers and does not require special software or additional storage on the recipient's receiving equipment (e.g., home computer).

### BRIEF DESCRIPTION OF THE DRAWINGS

These and other features and advantages provided by the invention will be better and more completely understood by referring to the following detailed description of presently preferred embodiments in conjunction with the drawings of which:

FIG. 1 illustrates an example IP Multicast System arrangement;

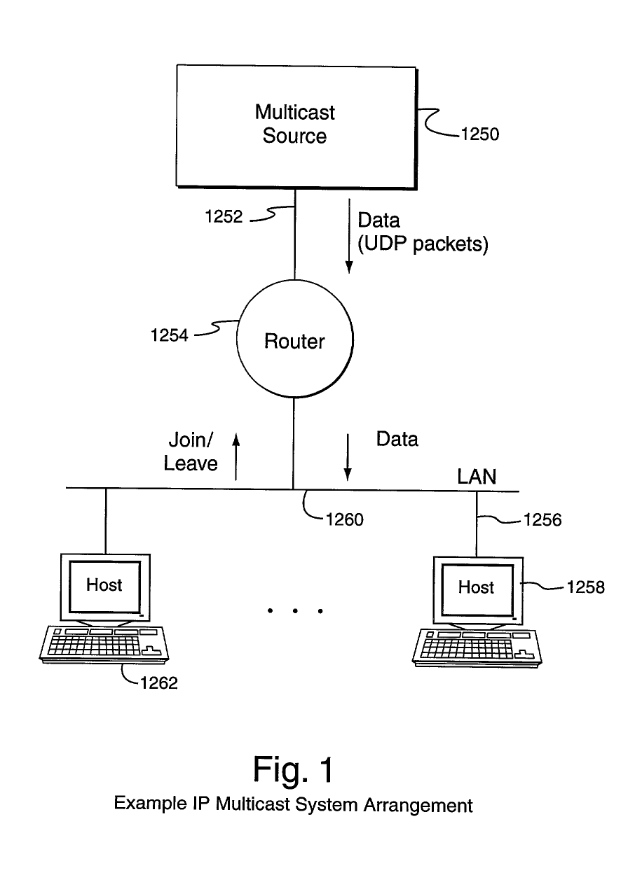

FIG. 2 illustrates encapsulation of data in an ATM cell;

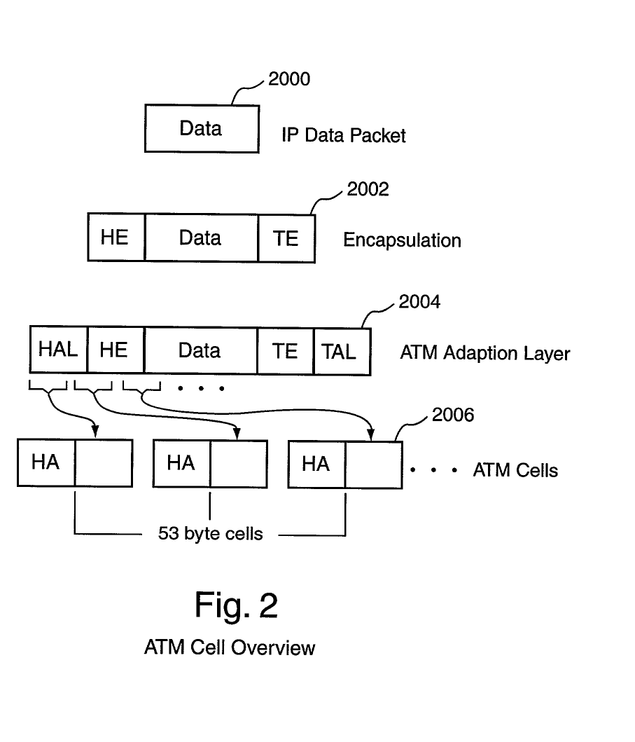

FIG. 3 is a high level schematic diagram of a conventional layer-3 digital communications network for illustrating one or more IP multicast injection points;

FIGS. 4a and 4b illustrate example high level embodiments for injecting IP Multicast content into an ATM network in accordance with the present invention;

FIG. 5 is a high level schematic diagram of an exemplary layer-2 digital communications network arrangement illustrating a legacy ISP arrangement for receiving IP multicast signals in accordance with the present invention;

FIG. 6 is a schematic block diagram illustrating example processing functions performed by the IAM of the present invention;

FIG. 7 is a block diagram illustrating an arrangement for providing local ad/commercial insertion in accordance with the present invention;

FIG. 8 is a block diagram illustrating an example of local ad/commercial insertion packet in accordance with the present invention;

FIG. 9 is a block diagram illustrating an example arrangement for providing personal-ad/commercial insertion in accordance with the present invention;

FIG. 10 is a block diagram illustrating an example IAM unit internal architecture;

FIG. 11 is a block diagram illustrating an example LAI unit internal architecture;

FIG. 12 is a schematic block diagram illustrating an example direct multicast content injection into an ATM network;

FIG. 13 is a schematic block diagram illustrating the internal hardware configuration of an exemplary AIMI unit; and

FIG. 14 is a schematic block diagram illustrating example AIMI internal processing architecture in accordance with the present invention.

### DETAILED DESCRIPTION OF EXAMPLE EMBODIMENTS OF THE INVENTION

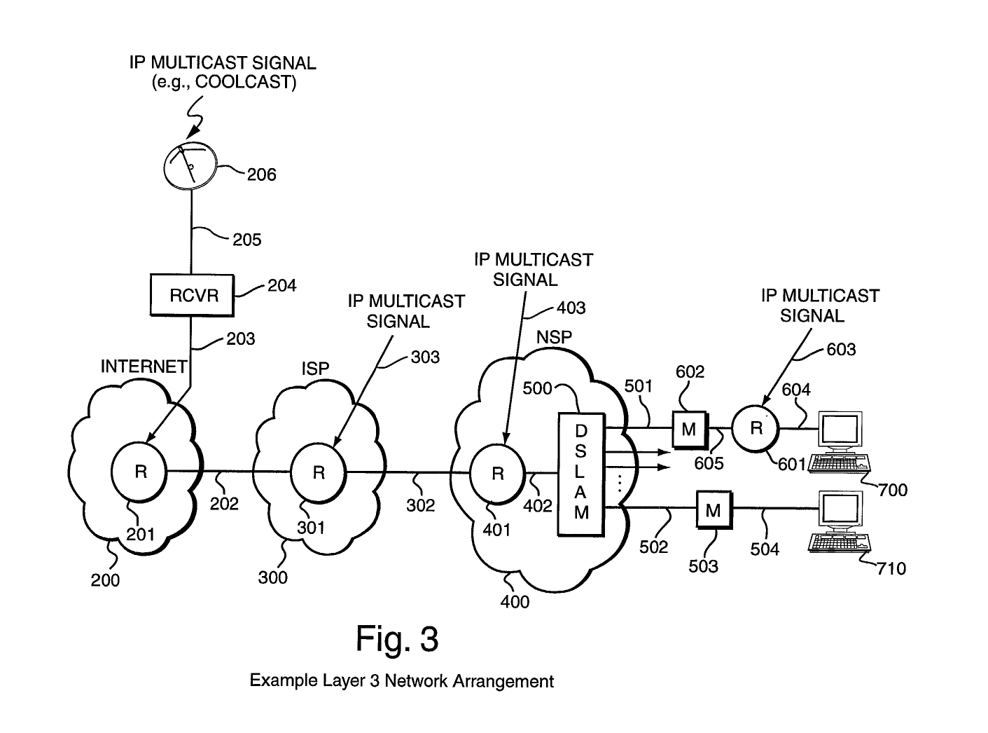

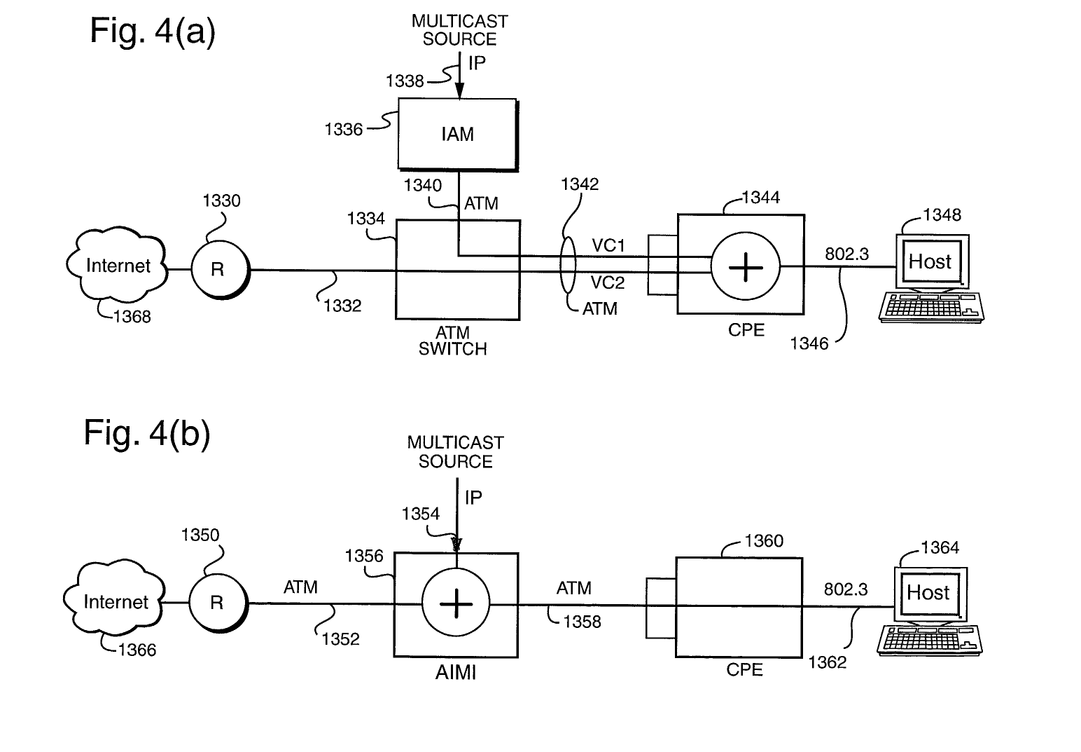

FIGS. 4a and 4b illustrate a high-level overview of two example approaches that may be utilized in accordance with the present invention for injecting IP multicast content into an ATM network. In the FIG. 4a approach, IP multicast data is converted into ATM protocol by a novel network element described herein as an IP ATM Multicaster unit (IAM). For the example embodiments described herein, the IAM of the present invention may be incorporated into either satellite receiver 204 or an ATM switch at NSP 400 (FIG. 3). Incorporation into the satellite receiver has a potential benefit in that it may be somewhat less expensive since this arrangement avoids the additional hardware required to convert the received signal from the satellite into an Ethernet signal for transport to an external IAM. Incorporating the IAM into the receiver in this manner also eliminates the Ethernet transport software and hardware in both the receiver and the IAM.

From IAM 1336, multicast content is carried on a virtual circuit, VC1, to customer premise equipment (CPE) 1334, where it is combined with the IP traffic flowing on a separate virtual circuit, VC2 (1332). Consequently, in the FIG. 4a example, the CPE must be of a type that is configured and provisioned for operation with multiple ATM virtual circuits (typically two). In FIG. 4b, an alternate embodiment is illustrated that utilizes a novel network element described herein as an ATM IP multicast inserter (AIMI). With this approach, AIMI 1356 is intended for use with a more conventional type CPE that is ordinarily provisioned and configured for operation with only a single ATM virtual circuit. Consequently, in the FIG. 4b example, AIMI 1356 converts IP data to ATM protocol and additionally performs suitable encapsulations necessary for compatibility with CPE 1360. Although the arrangement using an AIMI device requires more processing of data packets than the arrangement using the IAM device, it eliminates the need for a CPE that can support multiple virtual circuits.

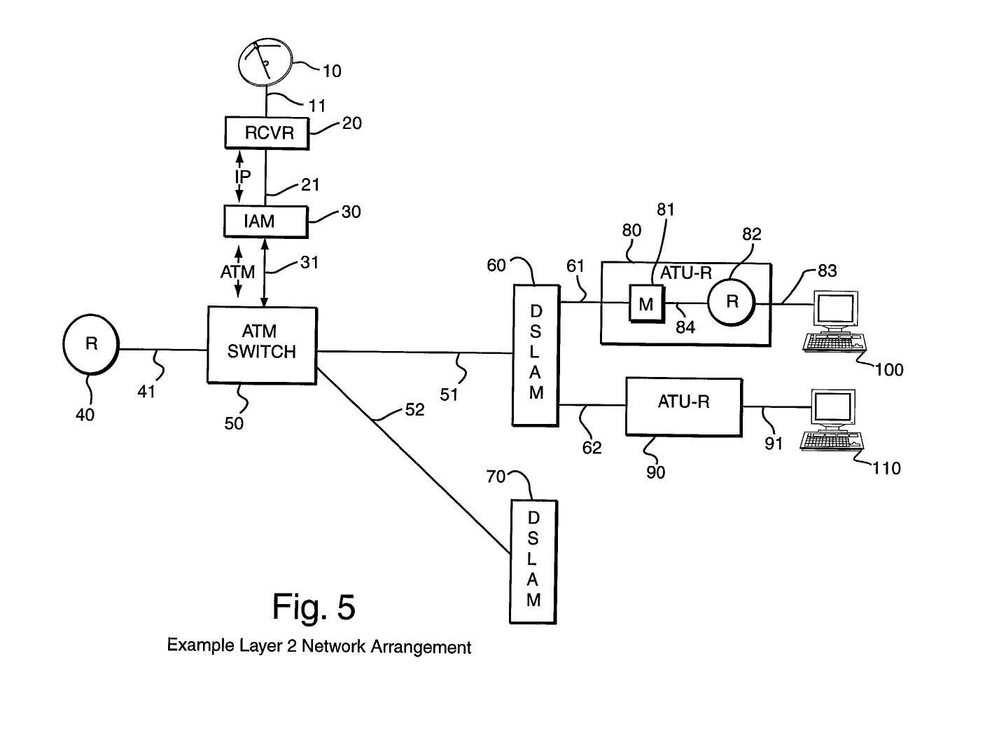

FIG. 5 shows a high level schematic diagram illustrating an exemplary layer-2 digital communications network of a legacy ISP having an arrangement for receiving IP multicast signals distributed in accordance with the present invention in a manner that bypasses at least a portion of conventional digital communications networks (e.g., the Internet) subject to congestion. In this example embodiment of the present invention, reserved one-way bandwidth portions of a point-to-multipoint satellite communications system are used to bypass congested digital communications network portions and provide IP multicast content via a downlink (10) to a receiver (20) being positioned with an ISP or NSP that provides services to an ATM DSL network. The arrangement shown is somewhat similar to the layer-3 network configuration shown in FIG. 3, with router 401 (or router 301) of FIG. 3 being replaced by ATM switch 50. In this example, router 301 of FIG. 3 and router 40 of FIG. 5 are functionally the same. Also, DSL modem 602 and router 601 of FIG. 3 are shown in FIG. 5 as a single device ATU-R 80. More particularly, the example embodiment of the invention shown in FIG. 5 illustrates the inclusion of an IP-ATM Multicaster (IAM) unit 30. The purpose of IAM 30 is to receive IP multicast traffic via line 21 from receiver 20 and then replicate the IP multicast packets in response to IGMP “joins” received, for example, from one or more content recipients/clients (100 and 110) and perform a conversion of the signals from IP protocol to ATM protocol for transport via line 31 to ATM switch 50. IAM 30 may also be used to insert locally originated content into the distributed multicast stream.

FIG. 5 illustrates how two virtual circuits between ATM switch 50 and ATU-R 80 and ATU-R 90 may be used to inject multicast content into a legacy ATM network. Basically, FIG. 5 shows the physical view corresponding to the logical view shown in FIG. 4a. For example, lines 1342 in FIG. 4a correspond to line 51 in FIG. 5. Of course, FIG. 4a omits DSLAM 60 of FIG. 5 for simplification.

Basically, the IAM forms a bridge between the IP and ATM worlds. The side corresponding to line 21 to IAM 30 communicates using IP (Internet protocol) while the side corresponding to line 31 communicates using ATM protocol. The IAM handles all encapsulation such as PPP (point-to-point protocol) and RFC1483 as well as AAL layer-5 in addition to performing replication of IP multicast content and handling multicast group address join and leave requests. In an example implementation, IAM 30 may also be incorporated into ATM switch 50.

The normal operating sequence is for a prospective multicast content recipient, e.g., client 100 (or 110), to first send an IP IGMP “join” request to router 82. Router 82 is pre-configured to map a specified range of IP multicast addresses to ATM VPINCIs that cause switch 50 to direct the ATM cells associated with the join request to IAM 30. A practical implementation is to assign all clients (100, 110) the same VPI and different VCIs. (Doing this allows ATM switch 50 to switch all multicast traffic only using the VPI, which greatly simplifies the provisioning of switch 50.) The IP join request sent by client 100, for example, traverses DSLAM 60 and switch 50 to IAM 30. The IAM converts the ATM cells back into IP packets where they are examined. The IAM then determines that it has received a “join” request for a specific IP multicast group and replicates packets received from IP multicast source 20 for the joined group, converts them to ATM cells with the proper VP/VCI of the client that sent the join request and sends IP multicast video content back to client 100. An IGMP “leave” request operates in an analogous fashion but with the resulting action of turning off packet replication in IAM 30.

It is acceptable if ATU-R 80 and ATU-R 90 send the join request on both virtual circuits. In this case, the join request of 100 (or 110) would be sent to both IAM 30 and router 40 over separate virtual circuits (see VC1 and VC2 at 1342 of FIG. 4a). In this case, router 40 is configured to ignore IGMP join requests. In this example, ATU-R 80 and ATU-R 90 may send all join requests to the VPI/VCIs corresponding to IAM 30 and router device 40. Device 40 is not necessarily limited to a router type device but may be any device that is capable of talking to router 82 such as, for example, a Subscriber Management System (SMS) (e.g., a Redback 1800 SMS). In such a case, the SMS is instructed to disable IGMP and it will ignore any IGMP requests coming from client 100. Additionally, router 82 must forward any packets received from IAM 30 to client 100. This allows router 82 to perform operations needed to deliver multicast content, such as for example, CoolCaSt™ IP transmissions, from satellite receiver 20 to clients such as 100 and 110. The above discussion assumes that ATM functions such as Serial Assembly and Reassembly (SAR) and ATM Adaptation Layer-5 are provided in IAM 30 and router 82. Additionally, router 82 may provide Point-to-Point Protocol (PPP) encapsulation that is understood by IAM 30.

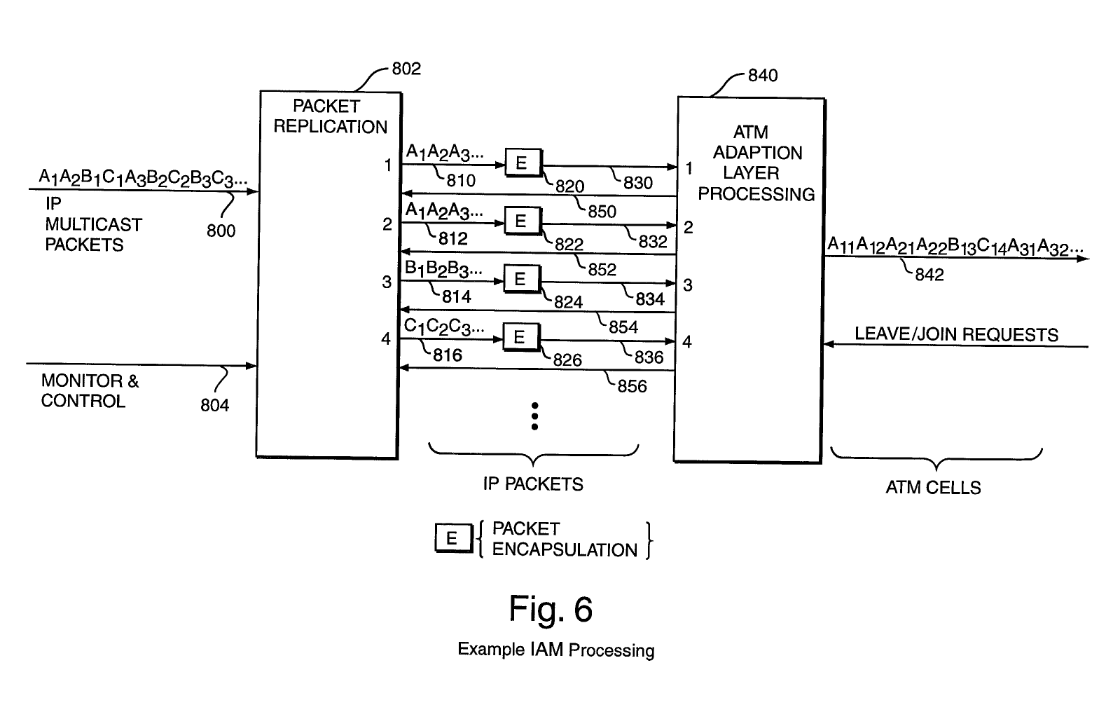

Referring now to FIG. 6, some basic operations performed by IAM 30 are illustrated in greater detail. For example, it is assumed that there are three channels of IP multicast data content arriving on input port 800, i.e., audio/video channels A, B and C. The individual data packets for channel A are identified as A₁, A₂, . . . An. Packet replication, 802, is employed to output replicas of the individual streams on outputs 810, 812, 814 and 816 in response to received IGMP join requests. In the ATM environment, outputs 810, 812, 814 and 816 correspond to the virtual circuits associated with four different content recipients/users.

In this example, it is assumed that the users associated with streams 810 and 812 both want to receive content from channel A, the user associated with stream 814 wants content associated with Channel B, and the user associated with stream 816 wants the content associated with channel C. Packet replicator 802 makes a copy received from input 800 and places it on the necessary output ports 810, 812, 814 and 816.

Any encapsulation processing (E), such as PPPOE, that may need to be performed, is performed (blocks 820, 822, 824, and 826) before ATM adaptation layer-processing 840. ATM adaptation layer (AAL) processing is responsible for converting the replicated IP multicast packets into appropriately formatted ATM cells. These 53-byte ATM cells are multiplexed onto output 842 for transport in the ATM network.

FIG. 6 also illustrates signal paths (850, 852, 854 and 856) from ATM interface 840 to packet replicator 802. These are the paths over which IGMP “leave” and “join” commands from recipients/users traverse. Signal Path pairs (810, 850), (812, 852), (814, 854) and (816, 856) form two-way per virtual circuit communication paths for packet replicator 802 to receive leave/join commands and output content to/from a specific virtual circuit.

In this example, Control Signal input 804 (which could also be line/input 800) is used to provide control commands and receive status information to/from packet replicator 802. This command control interface arrangement is provided to perform at least the following:

1. Enable packet replication on a per virtual circuit basis; and

2. Provide information about which IP multicast group address is being delivered to which virtual circuit.

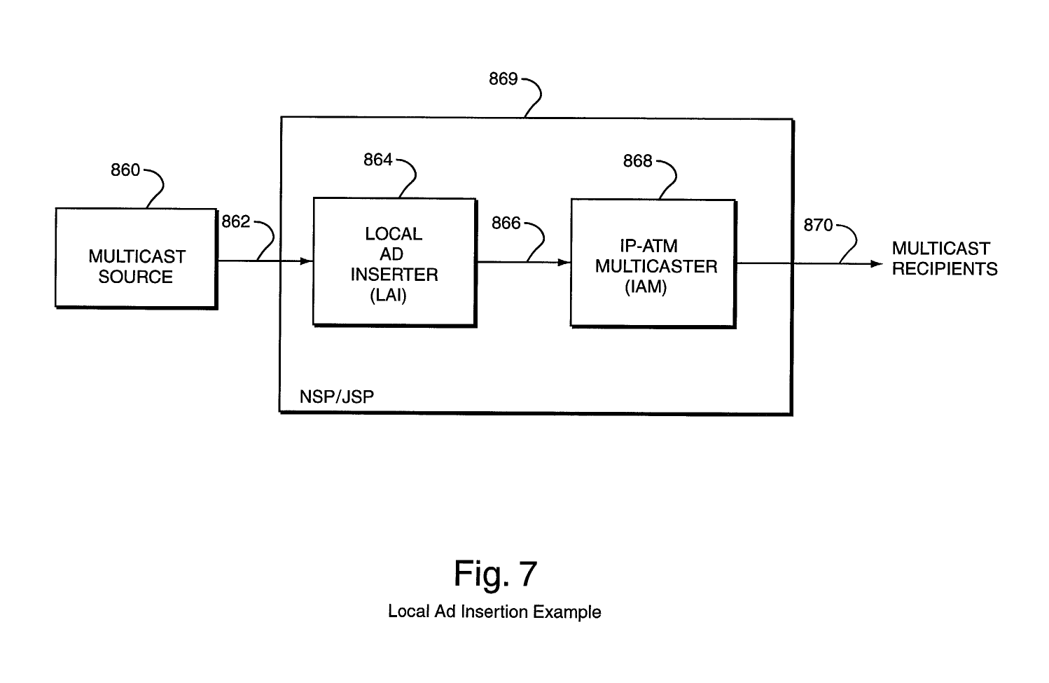

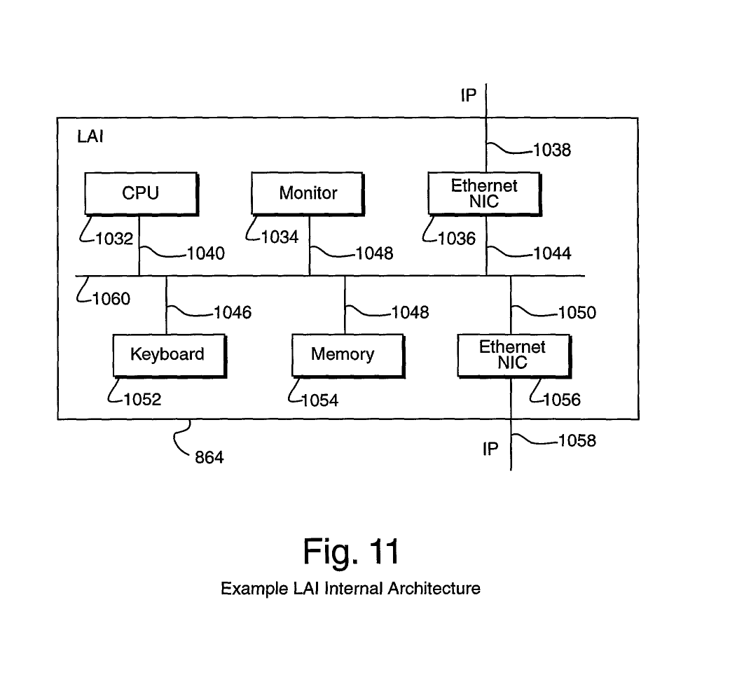

As previously illustrated in FIG. 5, a multicast source (i.e., receiver 20) may be directly connected to IAM 30. Referring now to FIG. 7, a local ISP/NSP network arrangement 869 is shown wherein a Local Advertisement/Commercial Insertion (LAI) device, 864, is placed in between multicast source 860 and IAM unit 868. LAI 864 examines IP multicast packets on line 862 from IP multicast content source 860 and determines whether certain received packets should be replaced or interspersed with predetermined packets of added content. For example, if the added packets contain audio/video advertisement content, then this process of packet substitution/insertion may be used to effectuate, for example, the insertion of demographically targeted commercials into the content stream. Some example hardware components for implementing the LAI are discussed below with respect to FIG. 11.

Since the insertion of local advertisements is most efficiently performed in the IP domain, such insertion is preferably performed on a per Multicast Group Address/Port basis before conversion to ATM is performed. In this example, LAI 864 includes a data storage device to hold an array of alternate packets for selective substitution/insertion into the multicast data stream (e.g., it may store an inventory of commercials), a description of which packets to substitute and information instructing when and where to insert a particular advertisement. Packet substitution may occur either in response to a specific external trigger, or a trigger embedded in the data stream arriving at input 800, or at specific predetermined times.

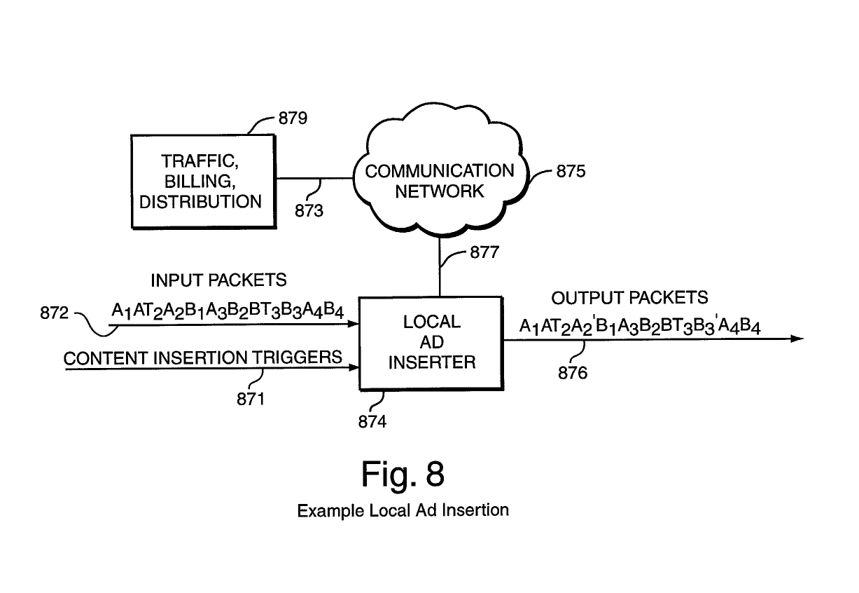

FIG. 8 illustrates an example of incoming local digital content multicast -packets arriving at an input (872) of a Local Advertisement Inserter (LAI) 874. In this example, Aₙ represents data packets for multicast stream A; Bₙ represents data packets for multicast stream B; ATₙ represents trigger packets for multicast stream A; BTₙ represents trigger packets for multicast stream B. External local content insertion commands or “triggers” may be provided to LAI 874 on input 871. These “triggers” may consist of specific commands or key data derived, for example, using external events or equipment such as real time clocks or other system conditions including manual input. Such time/event triggers may also be imbedded in the received IP multicast data stream 872. An example of such imbedded triggers interleaved with incoming IP multicast packets is also illustrated in FIG. 8 where Aₙ′ represents inserted/substituted packets in stream A and Bₙ′ represents inserted/substituted packets in stream B. Such input content insertion triggers alert the LAI that advertisement or other content insertion should occur on or after receipt of some future IP packet. In response to the trigger, predetermined the LAI retrieves predetermined digital audio/video content data (e.g., an advertisement), for example, from a local storage device such as a hard disk, and processes the content for seamless insertion into the received IP multicast content stream. Basically, the content insertion trigger provides either external or imbedded in-stream alerts the LAI to prepare locally stored content data for substitution or insertion within the multicast data stream.

In this example, a Traffic, Billing and Distribution (TBD) system 879, is responsible for providing local advertisements (or other content) to LAI 874 for insertion into the multicast stream the LAI. TBD 879 may also send information to LAI 874 to cause the inserted content to run in response to specific triggers. TBD 879 may also retrieve confirmation or activity log information from the LAI for confirming that an advertisement (or other content) was properly inserted into a specific IP multicast content channel and the time at which the particular additional content or advertisement was inserted.

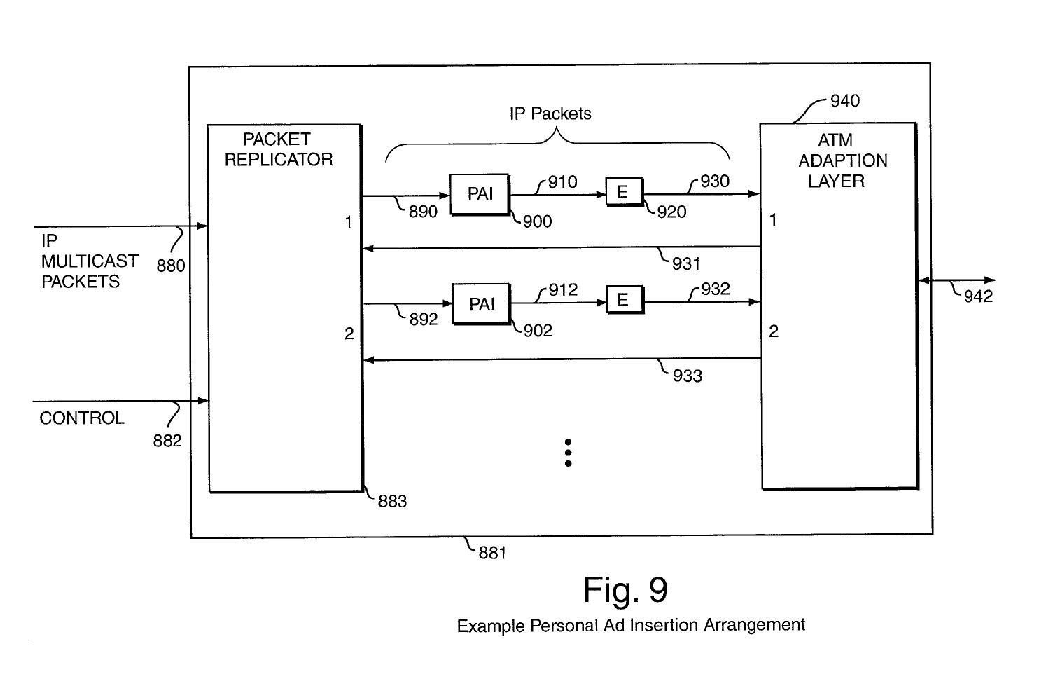

FIG. 9 illustrates an example of a “Personal” Ad Insertion (PAI) arrangement wherein a PAI device 900 is provided after packet replicator 883 for providing tailored advertisements or the like to specific individual recipients. Example hardware components for implementing the PAI are essentially the same as for the LAI discussed below in connection with FIG. 11. The FIG. 9 example allows for packet substitution to occur on an individual virtual circuit basis. Such an arrangement may, for example, be used for inserting different advertisements for individual recipients/users via different ATM virtual circuits. The logical functions of PAI 900 are essentially the same as that of LAI 874, except that it operates on a per virtual circuit basis instead of on an IP multicast group address/port basis.

### Example IAM Architecture

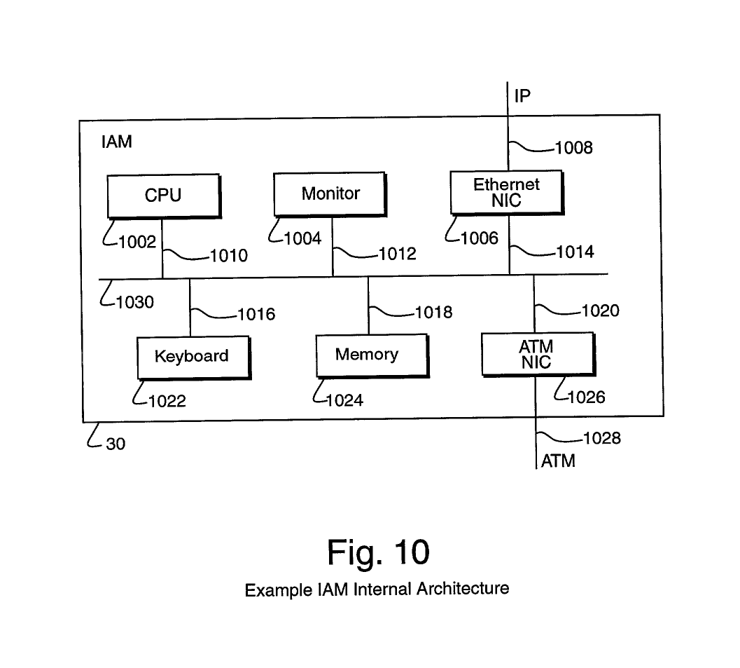

An example of the internal architecture of an IAM 30 is illustrated in FIG. 10. IAM 30 consists of a basic computer system core having CPU 1002, monitor 1004, keyboard 1022, and memory 1024, including one or more network interface cards (NICs), such as Ethernet NIC 1006 and ATM NIC 1026, coupled to system bus 1030. Ethernet NIC 1006 receives IP multicast packets from the IP multicast source and ATM NIC 1026 interfaces the IAM to the ATM environment. For example, data path 1008 may correspond to data path 21 of FIG. 5 and data path 1028 may correspond to data path 31 of FIG. 5. In the example embodiment, NIC 1006 may comprise, for example, a 3Com 3c509 and NIC 1026 may be, for example, a Marconi Fore Runner HE155. The remainder of the components illustrated in example FIG. 10 may comprise, for example, conventional Wintel® computer components, such as, a Pentium III 833 MHz processor running Microsoft Windows 2000 with, for example, 256 MB of RAM memory and 40 GB of disc storage. Software for controlling the IAM (such as provided in the example listing below), as well as any data buffers, may be stored in memory 1024.

Example Pseudo Code for Controlling IAM Operations

The following listing illustrates an example of pseudo code suitable for controlling basic processing functions of the IAM, such as, for example, controlling the IAM to listen to input from a receiver (e.g., receiver 20 in FIG. 5): (For this example, the IAM contains a table (MCTable) consisting of the following tuples: VPINCI, Group Address. On power up, the MCT Table is set to empty.)

```
        Loop forever {
    Packet = gets an IP packet from receiver 20
    GroupAddress = extract group address from ( Packet )
    For each entry in MCTable {
        If( MCTable.GroupAddress = = GroupAddress ) {
            Send the packet to the ATM interface going to switch 50
        }
    }
}
Example pseudo code of software for controlling IAM 30 for listening to
input 31 from switch 50:
Loop forever {
    Packet = get a packet from ATM interface to switch 50
    PacketType = extract packet type from ( Packet )
    If ( PacketType = = IGMP Join ) {
        VPI/VCI = extract VPI/VCI from ( Packet )
        GrpAddr = extract group address from ( Packet )
        Insert entry in MTCable ( VPI/VCI, GrpAddr )
    }
    else if ( PacketType = = IGMP Leave ) {
        VPI/VCI = extract VPI/VCI from ( Packet )
        GrpAddr = extract group address from ( Packet )
        Delete entry from MCTable ( VPI/VCI, GrpAddr )
    }
}
```

The components of the example IAM illustrated in FIG. 10 may also be used to implement the LAI (local add inserter) function. For example, LAI and IAM functionality may be implemented as separate processes running on CPU 1002. In this instance, communications between LAI 864 and an IAM 868 (see FIG. 7) may be accomplished using a conventional inter-process communication mechanism (IPC) such as shared memory or “pipes”. Likewise, the LAI and IAM of FIG. 7 could also be implemented using separate processors (CPUs) in the FIG. 10 arrangement, with communication link 866 between processors being a conventional Ethernet connection.

Incorporating IAM 30 into ATM switch 50 of FIG. 5 creates a switch-router arrangement that may be used to provide a somewhat more optimal implementation. In another embodiment, IAM 30 could be incorporated into satellite receiver 20 (FIG. 5). Such an embodiment has the advantage in that it is somewhat less expensive since receiver 20 must receive a signal from a satellite and convert it into Ethernet for transport via line 21 to IAM 30 where it is converted into ATM and output on line 31. Incorporating the IAM into the receiver eliminates the Ethernet transport software and hardware in both receiver 20 and IAM 30, since only ATM output is needed.

FIG. 11 illustrates an example internal component architecture for the LAI (local advertisement inserter). The components used to implement the LAI function are basically identical to the hardware components of the IAM unit, with the exception of the use of an Ethernet NIC 1056 to provide an IP output at 1058.

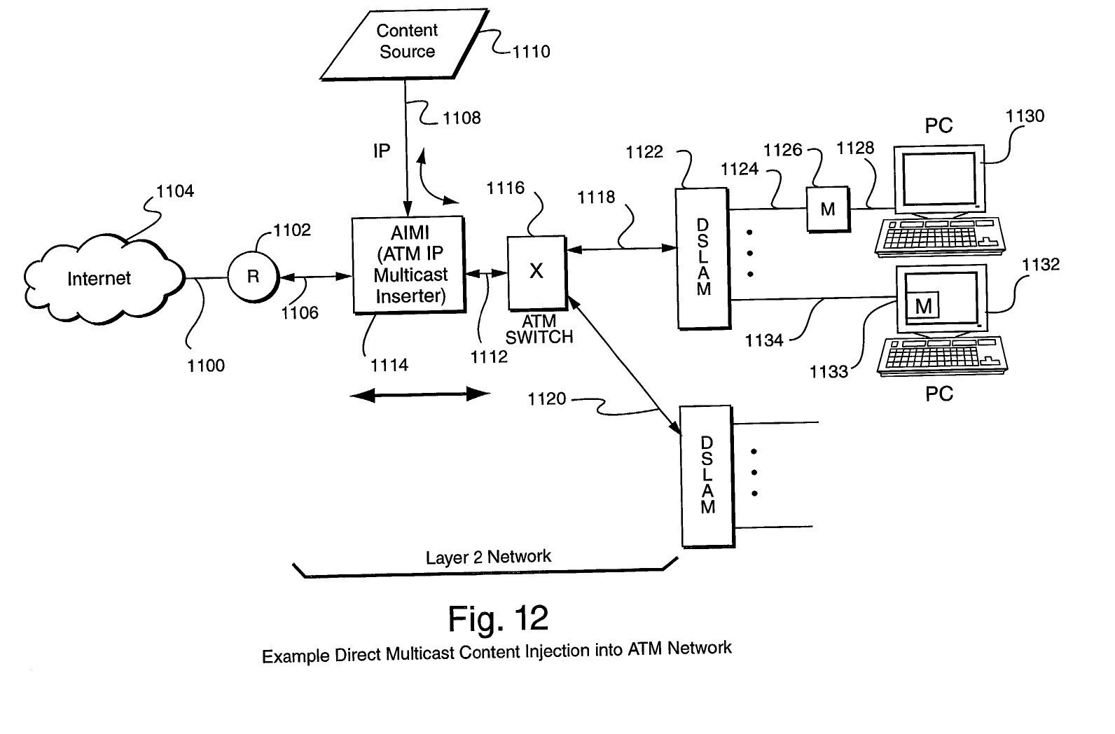

FIG. 12 illustrates an alternative example system arrangement for direct injection of multicast data content into an ATM network. This arrangement corresponds to the example of FIG. 4b and only needs a single ATM virtual circuit from router 1102 to modem 1126 (i.e., as opposed to the IAM embodiment of FIG. 4a, the CPE used with the AIMI of this arrangement is not required to be configured to support two or more virtual circuits). In this example, a typical layer-2 network, such as a DSL network, is connected to Internet 1104. One or more recipient host computers, 1130 and 1132 are connected via DSL modems, 1126 and 1133 to DSLAM 1122. One or more DSLAMs are connected to router 1102 via ATM switch 1116 and ATM IP Multicast Inserter (AIMI) 1114. IP multicast content 1110 is provided to AIMI 1114 via communications path 1108 which may, for example, be a separate dedicated backbone link, such as a satellite link. AIMI 1114 directly provides IP multicast content to one or more ATM virtual circuits and/or corresponding DSLAM units.

Although, AIMI 1114 is shown in FIG. 12 as positioned between router 1102 and ATM switch 1116, the AIMI may be placed anywhere in the data path between DSLAM 1122 and router 1102. However, it is most advantageous to place the AIMI as close to the DSLAM as possible for at least the following two reasons: 1) The bandwidth of the signal passed between the AIMI and the DSLAM may be potentially very large due to the injection of the multicast content and, therefore, minimizing the distance from the AIMI to the DSLAM will result in reduced data transport costs; and 2) Placing the AIMI close to the DSLAM minimizes the number of virtual circuits that must be processed by the AIMI and, thus, reduces the cost of the AIMI hardware. For the example illustrated in FIG. 12, AIMI 1114 must be capable of processing all virtual circuits from at least two or more DSLAMs (i.e., DSLAM 1120 and DSLAM 1122).

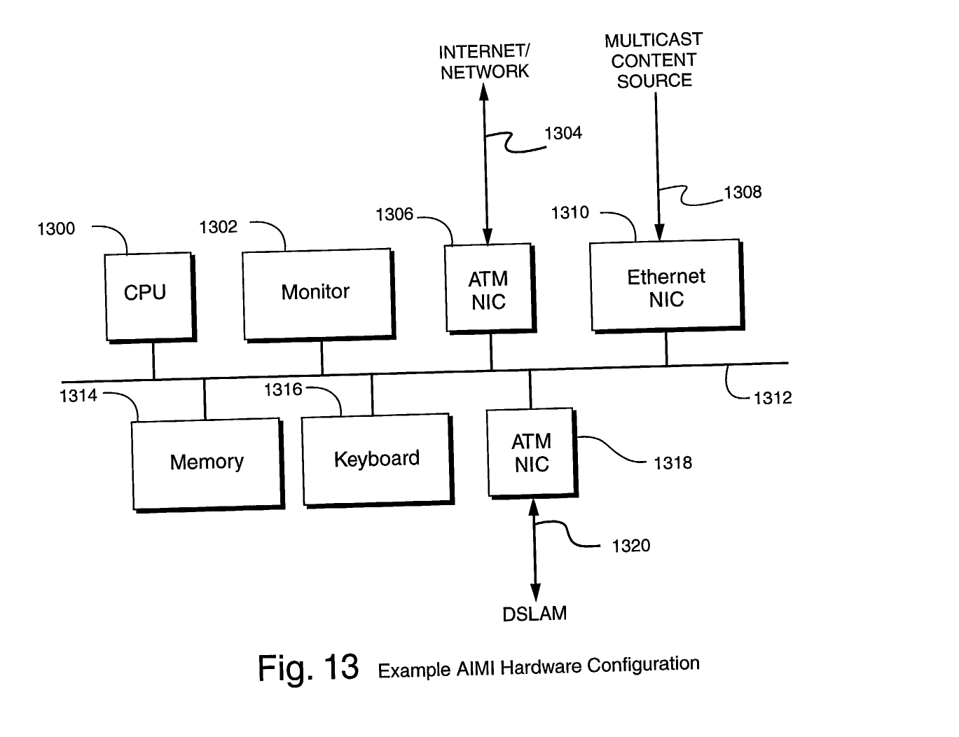

FIG. 13 illustrates an example high level component configuration for the AIMI. This example configuration may be based, for example, on an Intel Pentium III processor, 1300, running at 833 MHz, executing the Microsoft Windows 2000™ operating system. Memory 1314 may include, for example, 256 MB or more of RAM and 20 GB or more of disc. Monitor 1302 and keyboard 1316 may be conventional components. ATM NICs 1306 and 1318 may be, for example, a Marconi model Fore Runner HE 155. Ethernet NIC 1310 is a 3 Com model 3c509.

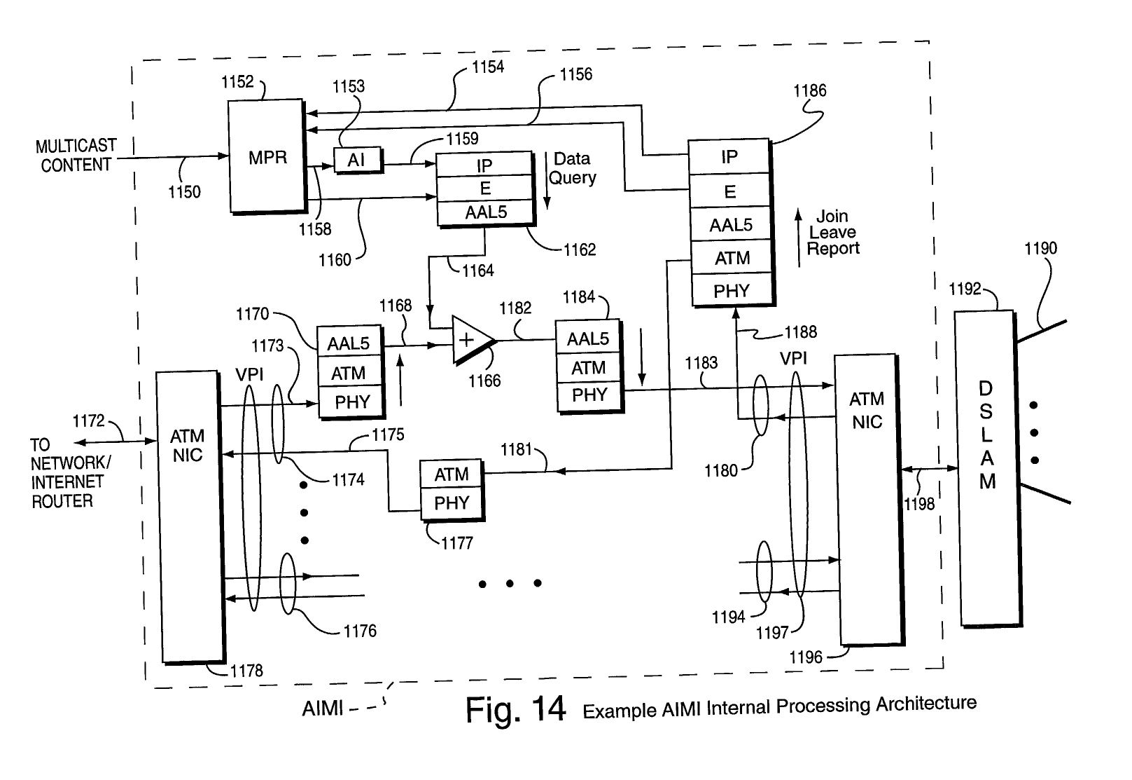

FIG. 14 provides a more detailed example of the internal processing architecture of the AIMI of FIG. 13. The functional components illustrated in FIG. 14 may be implemented with CPU 1300 (FIG. 13), for example, using known C⁺⁺ programming techniques. In the example of FIG. 14, data paths 1172, 1150 and 1198 correspond respectively to data paths 1106, 1108 and 1112 of FIG. 12.

As previously mentioned, ATM virtual circuits (VCs) are unidirectional, and therefore, a pair of VCs must be defined for providing a bi-directional circuit. Data path pairs 1174-1176 of Internet side ATM NIC 1178 represent VC pairs corresponding to data path pairs of DSLAM side ATM NIC 1180 and 1194.

Suitably encapsulated two-way TCP packets travel between ATM NICs ports 1198 and 1172. For example, when a data packet arrives via a virtual circuit at port 1198, ATM NIC 1198 receives the incoming ATM cells from DSLAM 1192. Conventional SAR functionality, for example as shown in block 1186, may be performed by ATM NIC 1196. ATM (SAR) functions (indicated as “ATM” in the various function blocks in FIG. 14) in the physical interface (indicated as “PHY” in the various function blocks in FIG. 14) are provided to ATM NIC 1178. The functionality of block 1177 may also be inside ATM NIC 1178. ATM cells are undisturbed as they travel from 1198 to 1172 via 1180, 1181 and 1175. The ATM cells egress from link 1172 and proceed, for example, to an Internet router (e.g., router 1102 in FIG. 12).

The response from the Internet side router (e.g., router 1102) arrives via data link 1172 where it travels via data paths 1173, 1168, 1182, 1183 and egresses via data path 1198. Multicast content injector 1166 simply passes complete IP packets encapsulated in AAL5 packets from input 1172 to output 1198 (as indicated by function blocks 1170 and 1184). In contrast, on the DSLAM side, as indicated by function paths 1180, 1181 and 1174, no ML support is provided in this example for reasons of efficiency (although AAL5 processing could be done in this direction as well). Protocol processing stacks are indicated by function blocks 1162, 1170, 1177, 1184 and 1186. These function blocks indicate protocol encapsulation and decapsulation processes performed converting to/from ATM protocol and IP protocol (the “PHY” stack layer indicating the physical connection layer).

As an example of the IP multicast functionality provided by the AIMI, consider an encapsulated IP packet containing an IGMP join request arriving via data path 1198. The join request packet is processed as indicated along functional paths 1180 and 1181 to protocol processing stack (block 1177), and also along functional paths 1154 and 1156 to multicast packet replicator (MPR) 1152. An IGMP packet travelling via path 1181 to protocol processing stack 1177 egresses at ATM NIC 1172 where it is forwarded to an Internet router, which in this arrangement is instructed to disregard any IGMP packets received via 1172.

Likewise, an IPv4 IGMP joined request is provided to MPR 1152 as indicated by function path 1154 after traversing up protocol processing stack 1186. Encapsulation information, such as, for example, the RFC 2516 session ID, is extracted and delivered to MPR 1152 along with the IGMP join request. Such encapsulation information is likewise used to build a properly encapsulated response when multicast content data is output from MPR 1152 via paths 1158 and 1160 for placement in an ATM data stream via data packet combiner stage 1166.

The function of MPR (multicast packet replicator) 1152 is to make a copy of an IP multicast packet that arrives via input path 1150 from a multicast source. Basically, MPR 1152 performs the various multicast system functions (such as outlined for example by publication RFC 2236) such as processing multicast joins, leaves, queries and reports.

The multicast data output at 1158 may next pass through an Al (advertisement/content inserter) device 1153, where a “personalized” advertisement may be inserted into a particular virtual circuit (i.e., inserted advertisement content may be designated to reach only particular specific individual recipients depending, for example, on their demographic profile). Once the advertisement or other audio/video or streaming data content has been inserted, it enters vertical stack 1162 where appropriate encapsulation and ATM adaptation layer functionality is performed. Packets emerging protocol processing block 1162 (e.g., at 1164) are “full” packets that may be intermixed at the AAL5 level with packets at combiner 1166 input 1168 after arriving from the Internet and after protocol processing via stack 1170.

The output of combiner stage 1166 comprises packets of data in AAL5 format that can be presented to the lower layers of vertical stack 1184. One of ordinary skill in the art will recognize that both IGMP and multicast UDP packets may be properly processed in accordance with the functional diagram illustrated by FIG. 14.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of providing IP mulitcast content to one or more recipients connected to a legacy ATM DSL network of the type using a conventional ATM switch for establishing one or more virtual circuits, comprising the steps of:
receiving an IP multicast signal from a multicast program source;
replicating predetermined data portions of the received IP multicast content;
converting an IP data stream from the IP multicast signal into a data stream conforming to ATM protocol, including performing appropriate data excapsulations and ATM adaptations layer processing for transmission of data over an ATM DSL network; and
providing the converted data stream to an ATM network switch for transmission to one or more recipient via one or more virtual circuits.

2. The method of claim 1 wherein the received IP multicast signal; comprises a plurality of IP multicast content channels and said replicating step includes replicating one or more content channels.

3. The method of claim 1 further including a step of responding to an IGMP join request to provide and/or replicate one or more predetermined data portions of the received mulitcast.

4. The method of claim 1 further including a step of responding to an IGMP leave request to terminate replicating and/or providing of one or more predetermined data portions of the received IP multicast.

5. The method of claim 1 wherein the IP multicast signal comprises multiple multicast content channels and predetermined data portions comprise data packets corresponding to a particular IP multicast content channel and the step of replicating is performed in response to establishment of an ATM virtual circuit upon receipt of and IGMP join request.

6. The method of claim 1 further including a step of providing information indicating an IP multicasting group address associated with multicast content currently provided on a particular ATM virtual circuit.

7. The method of claim 1 further including a step of inserting advertisement content or other audio/video content into received IP multicast content, the advertisement or other content being inserted into a received IP multicast content stream at a location of a service provider of said ATM network prior to the step of converting an IP data stream from the IP multicast signal into a data stream conforming to ATM protocol.

8. The method of claim 1 wherein the IP multicast signal comprises multiple multicast content channels and further includes a step of controlling access of each content recipient with respect to particular content channels.

9. An IP ATM multicaster (IAM) apparatus for injecting IP multicast content into a legacy ATM network of the type using a conventional ATM switch, comprising:
a first data signal interface that receives IP multicast content data from an IP multicast content source;
a second data signal interface that provides ATM data cells to an ATM switch; and
a programmable processor programmed to convert received IP multicast content data into a data stream conforming to ATM protocol, including performing appropriate data encapsulations and ATM adaptation layer processing for transmission of data over and ATM DSL network for communication with customer premise equipment configured to operate using two or more ATM virtual circuits.

10. The IP ATM multicaster (IAM) apparatus of claim 9 further comprising a keyboard data input device connected to said processor and an output display device connected to said processor.

11. The IP ATM multicaster (IAM) apparatus of claim 9 further comprising a memory device connected to said processor for storing data and programming instructions.

12. The IP ATM multicaster (IAM) apparatus of claim 9 wherein the processor is connected to an Ethernet type communications bus and the first data signal interface comprises an Ethernet network interface device for providing IP mulitcast content data to the processor.

13. The IP ATM multicaster (IAM) apparatus of claim 9 wherein the processor is connected to an Ethernet type communications bus and the second data signal interface comprises an Ethernet to ATM network inteface device for providing ATM data cells from the processor to the ATM switch.

14. An ATM IP multicast inserter (AIMI) apparatus for injecting IP multicast content into an ATM network virtual circuit, comprising:
a first data signal interface that receives IP multicast content data from an IP multicast content source;
a second data signal interface that sends and receives ATM data cells to or from one or more ATM virtual circuits via an ATM switch and a digital subscriber line asynchronous multiplexer (DSLAM);
a third data signal interface that interfaces ATM data cells to a network router; and
a programmable processor programmed to convert received IP multicast content data into a data stream conforming to ATM protocol, including performing appropriate data encapsulations and ATM adaptation layer processing for transmission of data over an ATM DSL network for communication with customer premise equipment configured to operate using a single ATM virtual circuit.

15. An ATM IP multicast inserter (AIMI) apparatus as set forth in claim 14 wherein the processor is further programmed to replicate predetermined data portions of received IP mulitcast content.

16. The ATM IP multicast inserter (AIMI) apparatus as set forth in claim 14 further comprising and IP content inserter apparatus connected to the programmable processor for inserting predetermined local IP content into selected ATM virtual circuits prior to encapsulation and ATM adaptation layer processing.

17. The ATM IP multicast inserter (AIMI) apparatus as set forth in claim 14 wherein the processor is connected to an Ethernet type communications bus and the first data signal interface comprises a Ethernet network interface for providing IP multicast content data to the processor.

18. In a point-to-multipoint IP content distribution system of the type using a satellite communications system to bypass congested portions of a digital communications network and having a satellite downlink receiver being positioned within an ISP, NSP or similar digital service network that provides or supplements the services of an ATM DSL network, and apparatus for providing IP multicast content to a conventional ATM switch used in a legacy ATM network to establish one or more ATM virtual circuits, comprising:
a programmable computer processor system having an internal digital data bus and including an interface for receiving an IP multicast content data stream from said receiver and an interface for providing ATM data cells to an ATM switch, said system programmed to convert a received IP multicast content data stream into a data stream conforming to ATM protocol, including performing appropriate data encapsulations and ATM adaptation layer processing for transmission of data over an ATM DSL network, wherein said apparatus acts as a bridge between multicast content distribution devices utilizing IP communications and multicast content distribution devices utilizing ATM communications.

19. The apparatus of claim 18 wherein said computer processing system includes a output display device and a keyboard for inputting data and/or programming instructions.

20. The apparatus of claim 18 wherein said interface for receiving an IP multicast content data stream from said receiver comprises an Ethernet network interface device.

21. The apparatus of claim 18 wherein said interface for providing ATM data cells to an ATM switch comprises and ATM network interface card.

22. The system of claim 18 wherein said apparatus for providing IP multicast content to said ATM switch is incorporated into said satellite downlink receiver.

23. The system of claim 18 wherein said apparatus for providing IP multicast content to said ATM switch is incorporated into an ATM switch.

24. The system of claim 18 further comprising a local content inserter device positioned within said ISP or NSP network coupled to the IP multicast source and to said apparatus for providing IP multicast content to an ATM switch, wherein the local content inserter device inserts advertisements content or other audio/video content into a received IP multicast content stream before IP multicast content is provided to said ATM switch.

25. The system of claim 24 wherein said local content inserter device comprises a programmable computer processor system having a memory device for storing at least portions of local audio/video content and includes an interface for communicating said local audio/video content to said apparatus for providing IP multicast content to an ATM switch.

26. The system of claim 25 wherein said portions of local audio/video content comprise one or more audio/video advertisements to be infected into said IP multicast stream.

27. The system of claim 24 wherein said local content inserter device is further connected to a separate billing and control processing system.

28. A method of providing IP multicast content to one or more recipients connected to a 2-layer ATM network of the type using a conventional ATM switch and a legacy DSLAM (Digital Subscriber Line Asynchronous Multiplexer) to distribute multicast content, comprising the steps:
receiving an IP multicast signal from a multicast program source at a location of an ISP, NSP or similar digital service network that provides or supplements the services of an ATM DSL network;
converting the received IP multicast content data into a data stream conforming to ATM protocol, including performing appropriate data encapsulations and ATM adaptation layer processing for transmission of data over an ATM DSL network for communication with customer premise equipment (CPE) configured to operate using tow or more ATM virtual circuits; and
providing said data stream to said ATM switch.

29. The method of claim 28 wherein the step of providing said data stream to an ATM switch further comprises a step of providing said data stream to one or more digital subscriber line asynchronous multiplexers (DSLAM) for distribution to ATM DSL network customer premise equipment.

30. The method of claim 28 further comprising a step of inserting advertisement content or other audio/video content into received IP multicast content, the advertisement or other content being inserted into a received IP multicast content stream at a location of a service provider of said ATM network prior to the step of converting an IP data stream from the IP multicast signal into a data stream conforming to ATM protocol.

31. The method of claim 28 further comprising a step of replicating portions of received IP multicast content prior to said step of converting multicast content data into a data stream conforming to ATM protocol.

32. The method of claim 28 further comprising a step of inserting advertisement content or other audio/video content into predetermined replicated portions of received IP multicast content, wherein said predetermined replicated portions are provided to predetermined ATM virtual circuits.

33. A method of providing IP multicast content to one or more recipients connected to a 2-layer network of the type using a conventional ATM switch and a legacy DSLAM (Digital Subscriber Line Asynchronous Mulitplexer) to distribute multicast content, comprising the steps of:
receiving an IP multicast signal form a multicast program source at a location of an ISP, NSP or similar digital service network that provides or supplements the services of an ATM DSL network;
converting the received IP multicast content data into a data stream conforming to ATM protocol, including performing appropriate data encapsulations and ATM adaptation layer processing for transmission of data over an ATM DSL network for communication with customer premise equipment (CPE) configured to operate using a single ATM virtual circuits; and
providing said data stream to said ATM switch.

34. The method of claim 33 wherein the step of providing said data stream to an ATM switch further comprises a step of providing said data stream to one or more digital subscriber line asynchronous multiplexers (DSLAM) for distribution to ATM DSL network customer premise equipment.

35. The method of claim 33 further comprising a step of inserting advertisement content or other audio/video content into received IP multicast content, the advertisement or other content being inserted into a received IP multicast content stream at a location of a service provider of said ATM network prior to the step of converting an IP data stream from the IP multicast signal into a data stream conforming to ATM protocol.

36. The method of claim 33 further comprising a step of replicating portions of received IP multicast content prior to said step of converting mulitcast content data into a data stream conforming to ATM protocol.

37. The method of claim 36 further comprising a step of inserting advertisement content or other audio/video content into predetermined replicated portions of received IP multicast content, wherein said predetermined replicated portions are provided to predetermined ATM virtual circuits.
